(19) United States
(12) Patent Application Publication
(10) Pub. No.: US 2010/0238809 A1
(43) Pub. Date: Sep. 23, 2010

(54) COMMUNICATION APPARATUS, CONTROL METHOD THEREOF, AND STORAGE MEDIUM

(75) Inventor: Yuki Ito, Kawasaki-shi (JP)

Correspondence Address: ROSSI, KIMMS & McDOWELL LLP., 20609 Gordon Park Square, Suite 150, Ashburn, VA, 20147, US

(73) Assignee: CANON KABUSHIKI KAISHA, Tokyo (JP)

(21) Appl. No.: 12/726,372

(22) Filed: Mar. 18, 2010

(30) Foreign Application Priority Data
Mar. 18, 2009 (JP) 2009-066188

(51) Int. Cl. H04L 12/26

(52) U.S. Cl. 370/242

(57) ABSTRACT

A communication apparatus capable of efficiently collecting information useful for failure analysis. In the communication apparatus, a packet acquisition unit starts acquiring packets when receiving, from an application unit via a network, an instruction to start packet acquisition, and completes acquiring packets upon receipt of an instruction to complete the packet acquisition. A packet holding unit holds acquired packets on a per destination basis and on a per protocol basis. If the data communication has not normally been completed, the packet holding unit searches for normal packet data, and groups and stores normal packet data and abnormal packet data which are the same in destination and in protocol.

### BACKGROUND OF THE INVENTION

1. Field of the Invention

The present invention relates to a communication apparatus for performing data communication with an external apparatus connected thereto via a network, and relates to a control method of the communication apparatus and a storage medium for executing the control method.

2. Description of the Related Art

Recently, various communication apparatuses such as personal computers, copying machines, and printers are connected to an enterprise network, and further different networks are connected together. Thus, the scale of networks becomes larger.

As a result, once a network failure occurs, there is a fear that a number of communication apparatuses are affected and business operations are disturbed. The causes of network failure are multiple, such as erroneous settings of communication apparatus and excess traffic. Thus, upon occurrence of a network failure, it is necessary to promptly locate the cause of the network failure and take a countermeasure.

As effective means for locating the cause of network failure, it is known to acquire network packets and analyze contents of the packets. Heretofore, to acquire network packets, a dedicated personal computer must be connected to a network hub considered to have trouble and packet acquisition software must be executed.

In recent years, however, some communication apparatuses have a packet acquisition function and are able to automatically acquire and hold communication packets.

For example, Japanese Laid-open Patent Publication No. 2001-274806 discloses a technique of using a packet acquisition function of an information processing apparatus, such as a printer or a copying machine, to acquire packets flowing through a network during a given time period and analyze the packets for making network settings of the information processing apparatus.

However, the above packet acquisition technique entails a problem that it is difficult to efficiently acquire and store a set of normal data and abnormal data which are required to analyze a network failure relating to the communication apparatus.

As an example, there is a failure such that transmission fails every time a communication apparatus attempts to transmit image data to a server on a network. In that case, once the image data transmission has failed, every subsequent transmission will fail. As a result, with the packet acquisition made after the occurrence of the failure, packets only for a case where transmission fails can be obtained, making it difficult to obtain packets transmitted and received in a successful transmission. As a result, it is impossible to make a comparison between a normal case and an abnormal case, and it takes much effort and labor to analyze the cause of the failure.

Although packets transmitted and received in an arbitrary time period can be acquired in advance as disclosed in Japanese Laid-open Patent Publication No. 2001-274806, the apparatus is required to hold a huge amount of packets, which poses a problem of memory resource shortage. In addition, a complicated operation is required to identify packets to be compared with packets acquired at occurrence of failure, among a huge amount of held packets.

### SUMMARY OF THE INVENTION

The present invention provides a communication apparatus capable of efficiently collecting information useful for failure analysis, and provides a control method of the communication apparatus and a storage medium storing a program for executing the control method.

According to a first aspect of this invention, there is provided a communication apparatus for performing data communication with an external apparatus connected thereto via a network, which comprises a determination unit configured to determine whether data communication with the external apparatus has normally been completed, a first holding unit configured to hold data transmitted to and received from the external apparatus during the data communication in a case where it is determined by the determination unit that the data communication with the external apparatus has normally been completed, and a second holding unit configured to hold data transmitted to and received from the external apparatus during the data communication so as to be associated with data held by the first holding unit in a case where it is determined by the determination unit that the data communication with the external apparatus has not normally been completed.

According to a second aspect of this invention, there is provided a control method of a communication apparatus for performing data communication with an external apparatus connected thereto via a network, which comprises a determination step of determining whether data communication with the external apparatus has normally been completed, a first holding step of holding data transmitted to and received from the external apparatus during the data communication in a case where it is determined in the determination step that the data communication with the external apparatus has normally been completed, and a second holding step of holding data transmitted to and received from the external apparatus during the data communication so as to be associated with data held in the first holding step in a case where it is determined in the determination step that the data communication with the external apparatus has not normally been completed.

According to a third aspect of this invention, there is provided a computer-readable storage medium storing a program for causing a computer to execute the control method according to the second aspect of this invention.

With this invention, it is possible to efficiently collect information useful for failure analysis.

Further features of the present invention will become apparent from the following description of exemplary embodiments with reference to the attached drawings.

### BRIEF DESCRIPTION OF THE DRAWINGS

FIG. 1 is a view showing the construction of a network system where an image forming apparatus according to a first embodiment of this invention is used;

FIG. 2 is a block diagram showing the hardware construction of the image forming apparatus in FIG. 1;

FIG. 3 is a block diagram showing the software structure of the image forming apparatus;

FIG. 4 is a view showing an example screen displayed on an operation panel in FIG. 2 for setting transmission destination information for image data transmission;

FIG. 5 is a view showing an example screen displayed on the operation panel for setting the number of pieces of storable normal data and the number of pieces of storable abnormal data;

FIG. 6 is a sequence diagram showing a packet acquisition process performed in response to a notification from an application unit in FIG. 3;

FIG. 7 is a flowchart showing the procedures of a process performed by a packet transmitter-receiver unit in FIG. 3;

FIG. 8 is a flowchart showing the procedures of a process performed by the application unit;

FIG. 9 is a view showing a filtering condition notified along with a process start notification from the application unit to a packet acquisition unit;

FIG. 10 is a view showing an application completion result notified along with a process completion notification from the application unit to the packet acquisition unit;

FIG. 11 is a flowchart showing the procedures of a process performed by the packet acquisition unit;

FIG. 12 is a view showing a hierarchy structure in which packet files are held by a packet holding unit shown in FIG. 3;

FIG. 13 is a flowchart showing the procedures of a process performed by the packet holding unit;

FIG. 14 is a block diagram showing the software structure of an image forming apparatus according to a second embodiment of this invention;

FIG. 15 is a flowchart showing the procedures of processing performed by a parent process shown in FIG. 14; and

FIG. 16 is a flowchart showing the procedures of processing performed by each of child processes shown in FIG. 14.

### DETAILED DESCRIPTION OF THE PREFERRED EMBODIMENTS

The present invention will now be described in detail below with reference to the drawings showing preferred embodiments thereof.

### First Embodiment

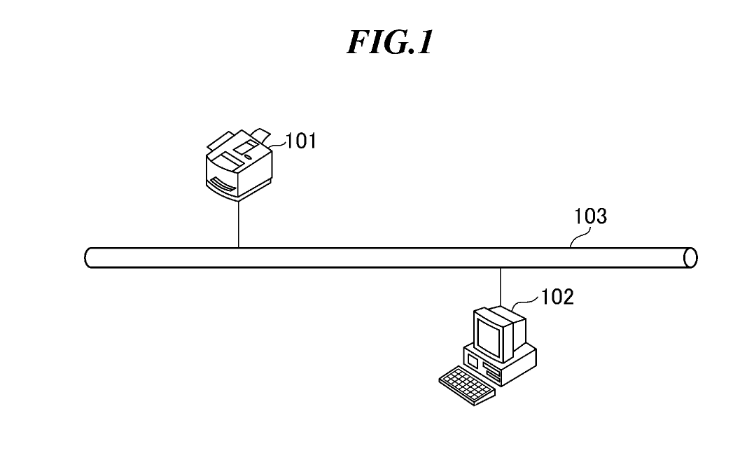

FIG. 1 shows the construction of a network system where an image forming apparatus is used as an example of a communication apparatus.

As shown in FIG. 1, an image forming apparatus 101 and a host computer 102 are connected for communication via a network 103. The image forming apparatus 101 has a function of transmitting image data scanned by a scanner to the host computer 102 via the network 103.

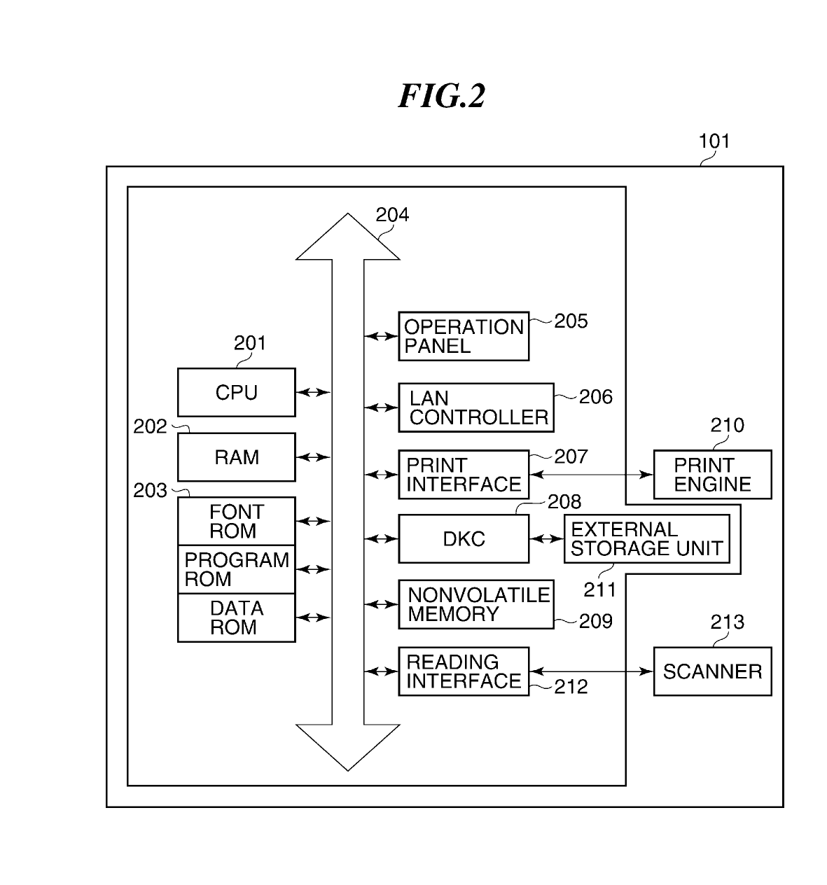

FIG. 2 shows in block diagram the hardware construction of the image forming apparatus 101.

The image forming apparatus 101 includes a CPU 201 that performs overall control of various devices connected to a system bus 204 based on a control program stored in a program ROM of a ROM 203 or stored in an external storage unit 211.

The CPU 201 outputs an image signal as output information to a print engine 210 connected via a print interface 207, and controls an image signal input from a scanner 213 connected thereto via a reading interface 212.

The ROM 203 has the program ROM in which control programs executable by the CPU 201, etc. are stored, a font ROM in which font data (including outline font data) used for generating the output information, etc. are stored, and a data ROM in which information utilized by the host computer 102, etc. are stored.

The CPU 201 is able to execute data communication with the host computer 102 and other image forming apparatuses on the network 103 via a LAN controller 206.

The RAM 202 mainly functions, e.g., as a main memory and a work area for the CPU 201. The memory capacity of the RAM 202 can be expanded by means of an option RAM connected to an expansion port, not shown.

The external storage unit 211 such as a hard disk (HDD) or an IC card is controlled by a disk controller (DKC) 208. The external storage unit 211 stores font data, emulation program, form data, etc., and is used as a job storage region for temporarily spooling a print job and for externally controlling the spooled job.

The external storage unit 211 is also used as a BOX data storage region for holding, as BOX data, image data read by the scanner 213 or image data for a print job. The data held in the HDD 211 is referred to from the network 103. The external storage unit 211 is also used as a region for storing BOX data to be printed.

An operation panel 205 has software keys that enable a user to input various information. The external storage unit 211 may be configured to be able to be connected with option font cards or external memories storing, e.g., a program for interpreting printer control language of different language system. A nonvolatile memory 209 stores various setting information, which are set via the operation panel 205.

Although not illustrated, the image forming apparatus 101 can optionally be mounted with extension apparatuses such as a finisher having stapling and sorting functions and an apparatus having a double-sided printing function. Operations of these apparatuses are controlled by the CPU 201.

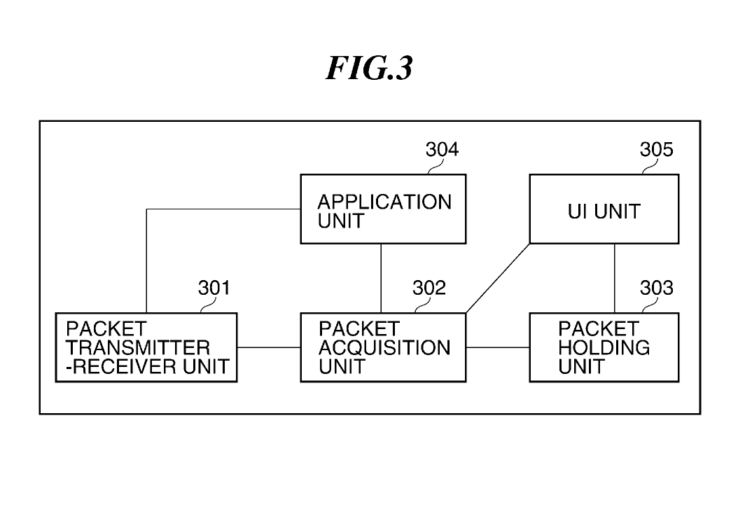

FIG. 3 shows in block diagram the software structure of the image forming apparatus 101.

As shown in FIG. 3, the image forming apparatus 101 includes a packet transmitter-receiver unit 301 that controls packet transmission and reception between itself and the host computer 102 at the time of data communication therebetween. In the data communication, image data input from, e.g., the scanner 213 is transmitted to the host computer 102 in accordance with an instruction from an application unit 304. A packet acquisition unit 302 is controlled in accordance with instructions from the application unit 304 and a UI unit 305.

The packet acquisition unit 302 acquires packets transmitted from and received by the packet transmitter-receiver unit 301 via the network 103, and causes a packet holding unit 303 to hold the acquired packets as a packet file. The packet acquisition unit 302 can apply filtering at the time of packet acquisition in order to extract and acquire only packets matching a condition.

The packet holding unit 303 creates a subdirectory based on a result of data communication (normal completion or abnormal completion), destination information (IP address), and protocol used, and holds the packet file therein. The packet holding unit 303 is able to search for data relating to particular destination information or relating to a protocol from all the held data. The packet holding unit 303 holds any number of packet files not exceeding the maximum number of held files, which is designated on the UI unit 305.

All the software blocks shown in FIG. 3 are stored in the external storage unit 211 or in the ROM 203, and loaded as an executable program into the RAM 202 when the image forming apparatus 101 is activated. Subsequently, the software blocks are concurrently executed by the CPU 201.

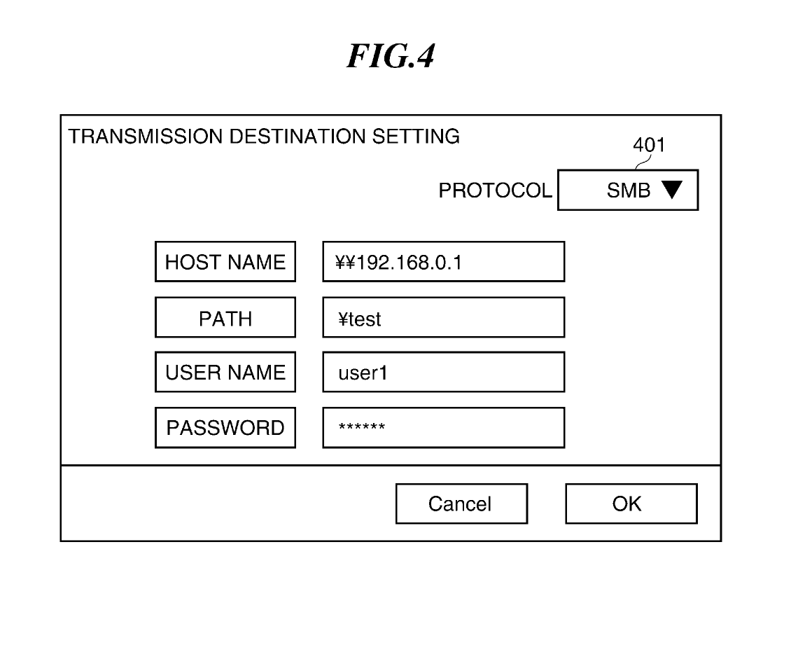

FIG. 4 shows an example screen displayed on the operation panel 205 in FIG. 2 for setting transmission destination information for image data transmission.

As shown in FIG. 4, host name, path, user name, password, and protocol can be set on the screen, as information required for transmission of image data to the host computer 102. The host name may not be in the form of IP address.

If not in the form of IP address, an input host name is converted into an IP address using DNS or other means. As a protocol, SMB, FTP, WebDAV, or the like can be selected. When a button 401 is depressed, a list of selectable protocols is displayed.

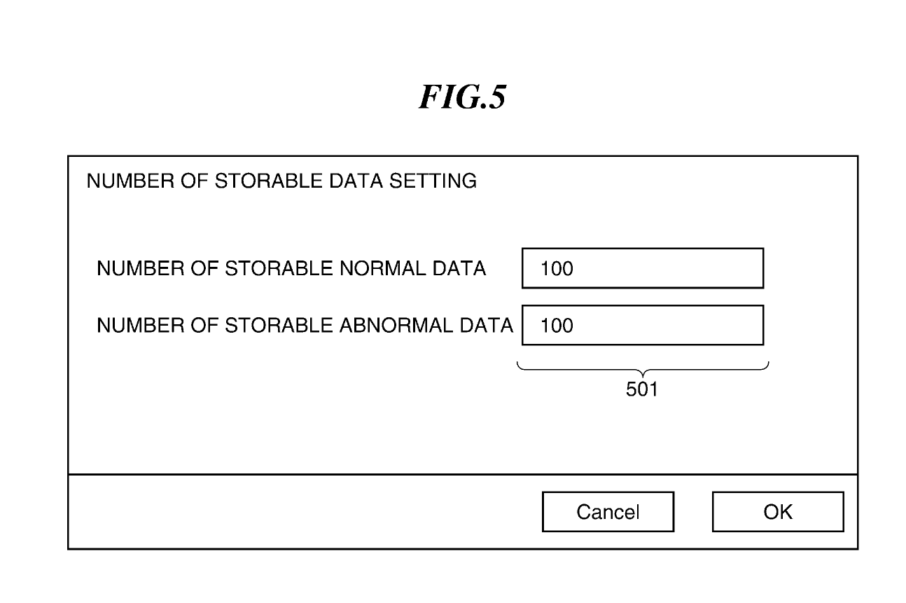

FIG. 5 shows an example screen displayed on the operation panel 205 in FIG. 2 for setting the number of pieces of storable normal data and that of storable abnormal data.

As shown in FIG. 5, the number of pieces of storable normal data (normal packet data) and that of storable abnormal data (abnormal packet data) can be set in advance in a region 501.

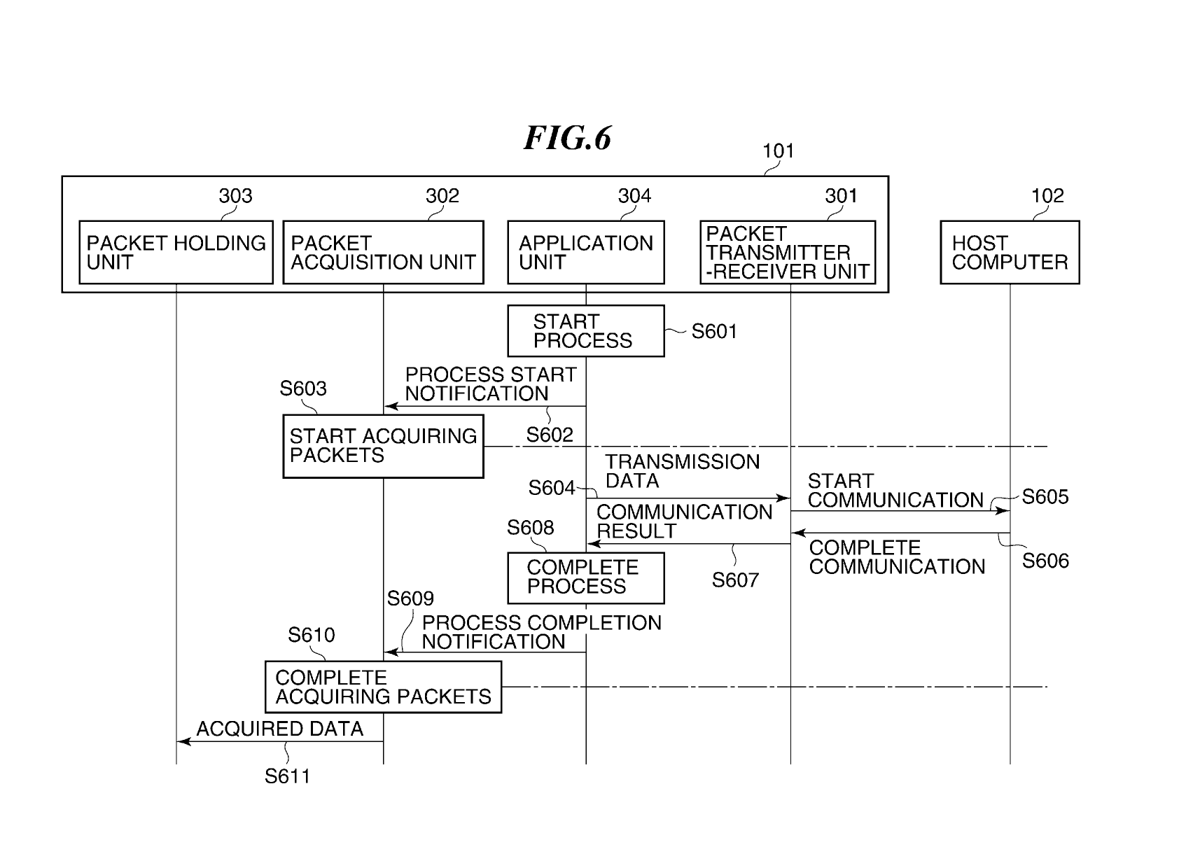

FIG. 6 shows in sequence diagram a packet acquisition process performed in response to a notification from the application unit 304.

As shown in FIG. 6, the application unit 304 starts the process (S601), and notifies the packet acquisition unit 302 of the start of the process (S602). Upon receipt of the notification from the application unit 304, the packet acquisition unit 302 starts acquiring packets (S603). The application unit 304 transmits transmission image data to the packet transmitter-receiver unit 301 (S604), and the packet transmitter-receiver unit 301 starts communication (transmission of the image data) (S605).

Subsequently, the packet transmitter-receiver unit 301 completes the communication (S606), and delivers a communication result to the application unit 304 (S607). The application unit 304 completes the process (S608), and notifies the packet acquisition unit 302 of the completion of the process (S609). When receiving the notification from the application unit 304, the packet acquisition unit 302 completes acquiring packets (S610), and delivers acquired data to the packet holding unit 303 (S611).

As described above, the packet acquisition unit 302 starts acquiring packets when receiving from the application unit 304 an instruction to start acquisition of packets, and completes acquiring packets when receiving an instruction to complete the acquisition of packets.

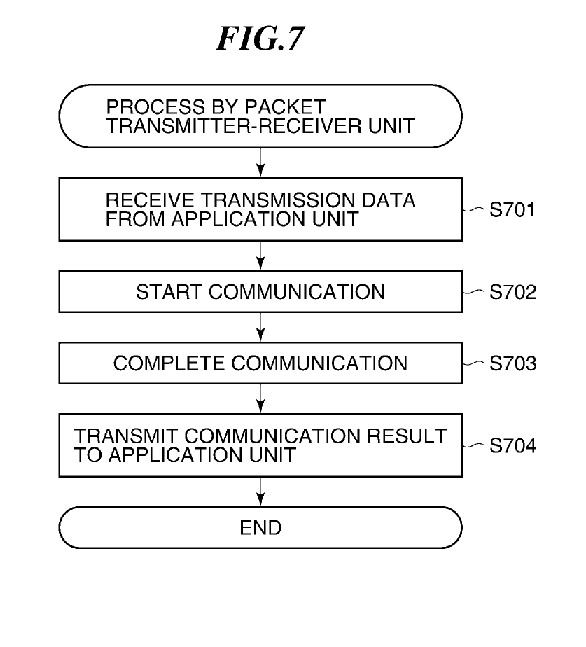

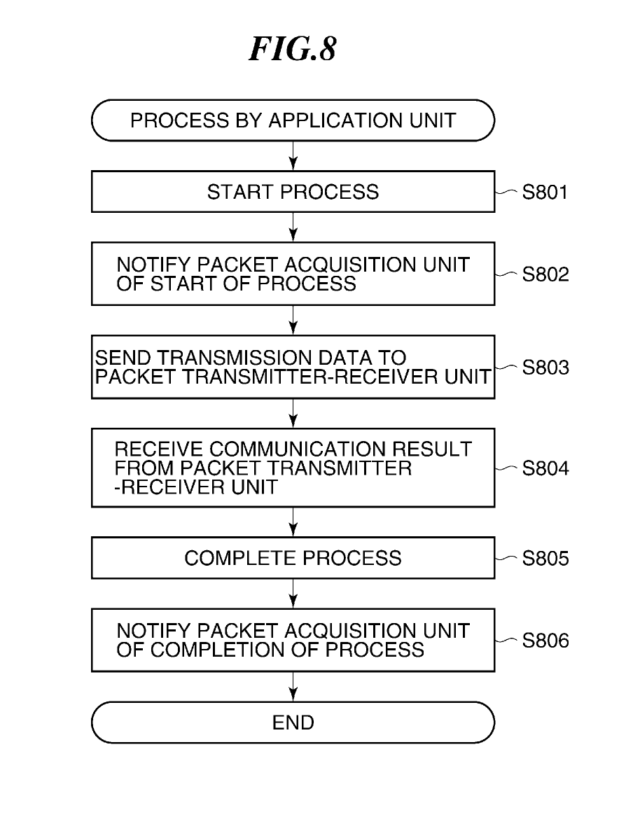

FIG. 7 shows in flowchart the procedures of a process performed by the packet transmitter-receiver unit 301, and process steps are denoted by step numbers following letter S (Ditto in FIGS. 8, 11, 13, 15 and 16).

In S701, the packet transmitter-receiver unit 301 receives transmission data from the application unit 304. In S702, the unit 301 starts data communication with an external apparatus. In S703, the packet transmitter-receiver unit 301 completes the data communication with the external apparatus. In S704, the transmitter-receiver unit 301 sends a communication result to the application unit 304.

FIG. 8 shows in flowchart the procedures of a process performed by the application unit 304.

In S801, the application unit 304 starts the process. In S802, the application unit 304 notifies the packet acquisition unit 302 of the start of the process along with a filtering condition. The filtering condition is represented by destination information and a protocol to be used.

In S803, the application unit 304 sends transmission data to the packet transmitter-receiver unit 301. In S804, the application unit 304 receives a communication result from the transmitter-receiver unit 301. In S805, the application unit 304 completes the process. In S806, the application unit 304 notifies the packet acquisition unit 302 of the completion of the process along with an application completion result.

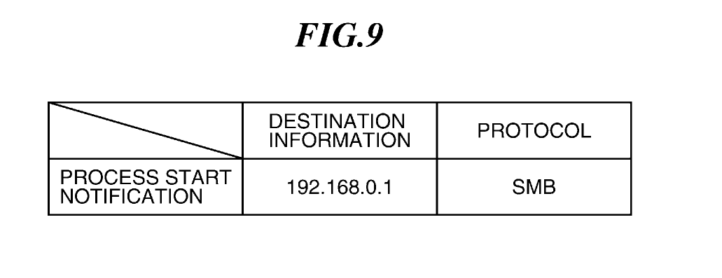

FIG. 9 shows a filtering condition notified along with a process start notification from the application unit 304 to the packet acquisition unit 302.

As shown in FIG. 9, the application unit 304 notifies the packet acquisition unit 302 of a filtering condition (destination information and a protocol to be used) along with a process start notification. In accordance with the filtering condition, the packet acquisition unit 302 extracts and acquires desired packets from among packets received via the network.

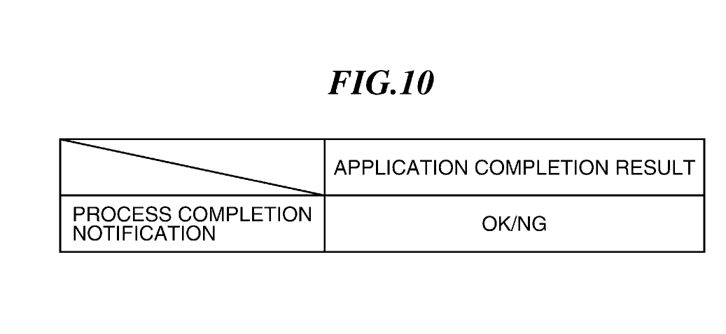

FIG. 10 shows an application completion result notified along with a process completion notification from the application unit 304 to the packet acquisition unit 302.

As shown in FIG. 10, the application completion result, either normal or abnormal, is notified together with the process completion notification.

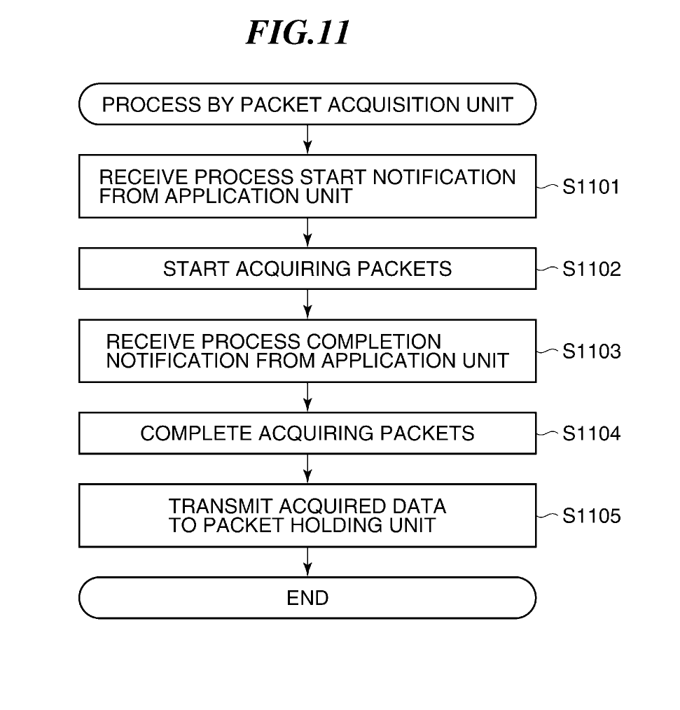

FIG. 11 shows in flowchart the procedures of a process performed by the packet acquisition unit 302.

In S1101, the packet acquisition unit 302 receives from the application unit 304 a process start notification along with a filtering condition. The filtering condition is represented by a destination IP and a protocol to be used. In S1102, the packet acquisition unit 302 starts acquiring packets.

In S1103, the packet acquisition unit 302 receives from the application unit 304 a process completion notification along with an application completion result. In S1104, the unit 302 completes acquiring packets. In S1105, the packet acquisition unit 302 delivers to the packet holding unit 303 acquired data along with the application completion result.

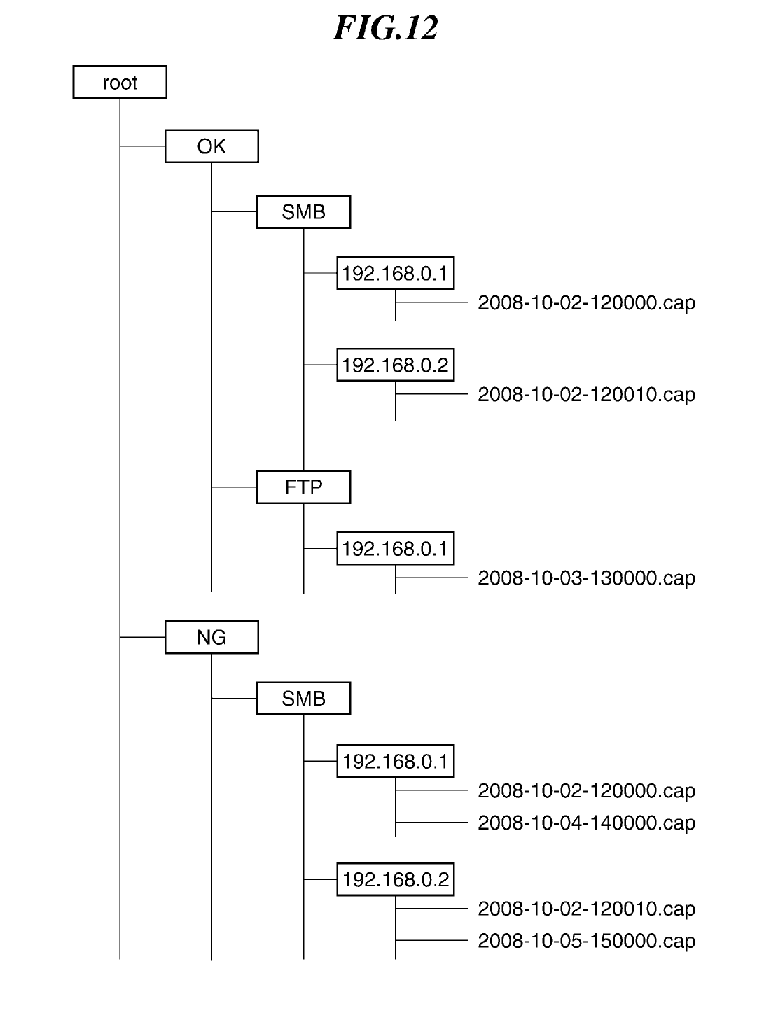

FIG. 12 shows a hierarchy structure in which packet files are held by the packet holding unit 303.

The most significant directory in the hierarchy is a root directory under which subdirectories are created. Specifically, a normal directory for storing normal data (packets acquired during data communication which has normally been completed) and an abnormal directory for storing abnormal data (packets acquired during data communication which has not normally been completed) are created under the root directory.

Protocol subdirectories are created on a per protocol basis under the normal directory, and destination subdirectories are created on a per destination information basis under each protocol subdirectory. Each packet file is held in a corresponding subdirectory which is the same in protocol and in destination as the packet file.

Similarly, protocol subdirectories are created on a per protocol basis under the abnormal directory, and destination subdirectories are created on a per destination information basis under each protocol subdirectory. Each packet file is held in a corresponding subdirectory which is the same in protocol and in destination as the packet file. As will be described later, if a packet file which is the same in protocol and in destination (or only in destination) is present in the normal directory, the packet file is copied to a corresponding subdirectory in the abnormal directory which is the same in protocol and in destination as the packet file. Packet acquisition time is set as a file name for a corresponding packet file, whereby duplication of file names is prevented.

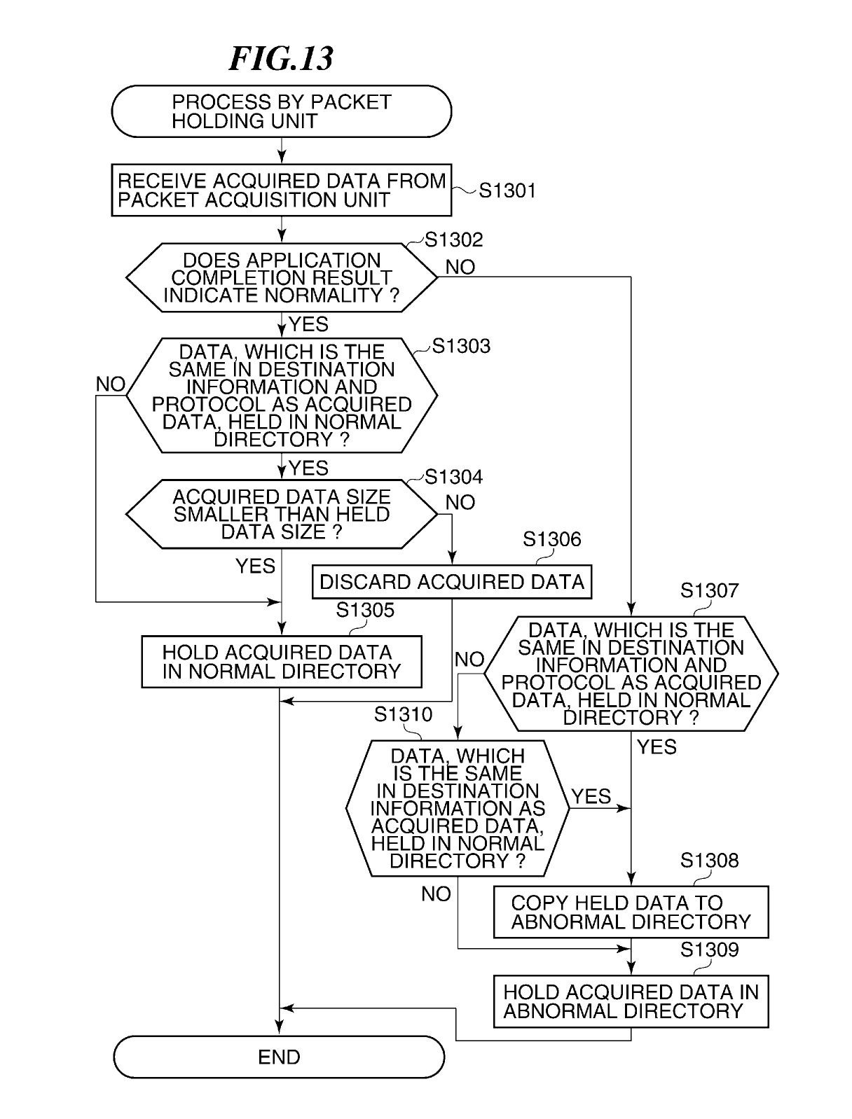

FIG. 13 shows in flowchart the procedures of a process performed by the packet holding unit 303 in FIG. 3.

In S1301, the packet holding unit 303 receives from the packet acquisition unit 302 acquired data along with an application completion result. In S1302, the packet holding unit 303 determines whether the application completion result indicates normality or abnormality. If the result indicates normality, the packet holding unit 303 searches for the normal directory in S1303 to determine whether data which is the same in destination information and in protocol as the acquired data is already held in the normal directory.

If it is determined in S1303 that there is no such held data in the normal directory, the packet holding unit 303 holds the acquired data in the normal directory in S1305. If it is determined in S1303 that there is such held data in the normal directory, the packet holding unit 303 compares in S1304 the file size of the acquired data and that of the held data to determine whether the file size of the acquired data is smaller than that of the held data.

If it is determined in S1304 that the file size of the acquired data is smaller than that of the held data, the packet holding unit 303 discards the held data and holds the acquired data in the normal directory instead of the held data in S1305. If it is determined in S1304 that the file size of the acquired data is not smaller than that of the held data, the packet holding unit 303 discards the acquired data in S1306.

If it is determined in S1302 that the application completion result indicates abnormality, the packet holding unit 303 searches for the normal directory in S1307 to determine whether data which is the same in destination information and in protocol as the acquired data is already held in the normal directory.

If it is determined in S1307 that such held data is present in the normal directory, the packet holding unit 303 copies the held data to the abnormal directory in S1308, and holds the acquired data in the same abnormal directory in S1309.

If it is determined in S1307 that in the normal directory there is no held data which is the same in destination information and in protocol as the acquired data, the packet holding unit 303 searches for the normal directory in S1310 to determine whether data which is the same only in destination information as the acquired data is held in the normal directory.

If it is determined in S1310 that there is held data which is the same only in destination information as the acquired data in the normal directory, the packet holding unit 303 copies the held data to the abnormal directory in S1308, and holds the acquired data in the abnormal directory in S1309.

If it is determined in S1310 that there is no held data which is the same only in destination information as the acquired data, the packet holding unit 303 holds in S1309 the acquired data in the abnormal directory.

In this embodiment, the packet holding unit 303 searches for the normal directory in accordance with the same condition as the filtering condition of the packet acquisition unit 302.

If a result of the normal directory search indicates that in the normal directory there is no held data which is the same in destination and in protocol as acquired data, the packet holding unit 303 again performs the normal directory search while relaxing the search condition such that held data is required to be the same only in destination as the acquired data.

If the application completion result indicates normality, the packet holding unit 303 searches for normal packet data held on a per destination basis, and compares the data size of acquired data and that of held data. Then, if the data size of the acquired data is smaller than the held data, the held data is replaced by the acquired data and the acquired data is held.

As described above, in the first embodiment, if data communication has not normally been completed, data transmitted and received during the data communication is held so as to be associated with data acquired during another data communication which was normally completed. As a result, to analyze the cause of a failure using acquired data (transmitted and received packets), it is possible to compare data acquired in a normal state with data acquired in an abnormal state, whereby the efficiency of operation can be improved.

### Second Embodiment

In the following, a description will be given of the procedures of acquiring packets in a case where pieces of image data are simultaneously transmitted to a plurality of destinations at a time.

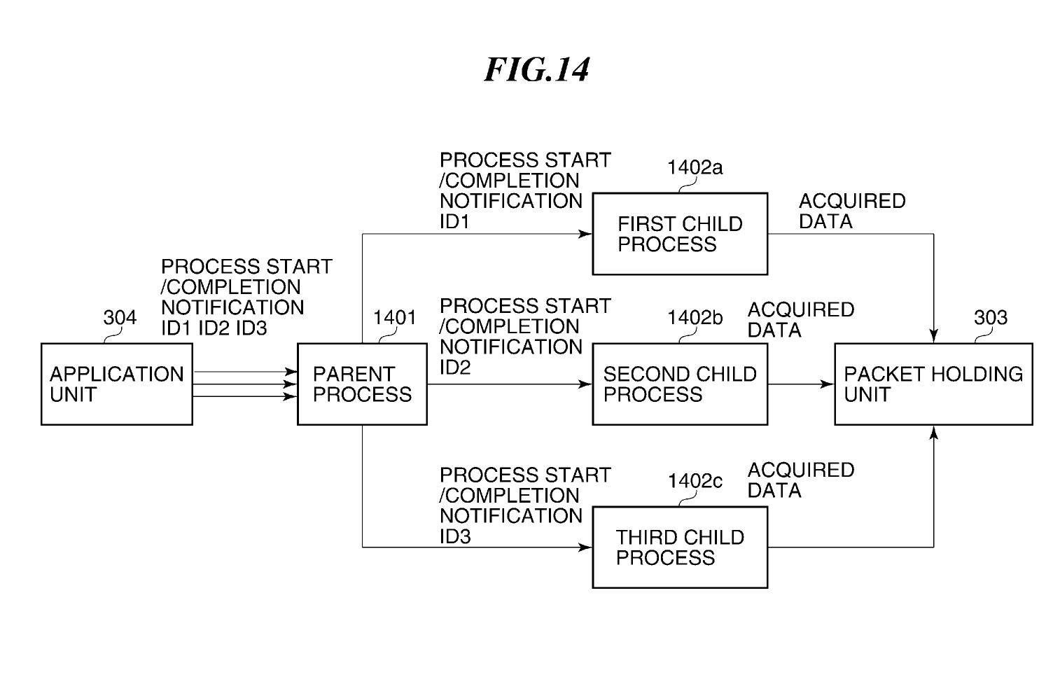

FIG. 14 shows in block diagram the software structure of an image forming apparatus 101 according to a second embodiment of this invention.

A parent process 1401 by the packet acquisition unit creates a child process 1402 each time the parent process 1401 receives a process start notification from the application unit 304. Thus, the parent process 1401 is able to create a plurality of child processes (three child processes 1402a, 1402b, and 1402c in the example in FIG. 14). At these times, the parent process 1401 receives from the application unit 304 process IDs for identifying the child processes 1402a, 1402b, and 1402c, i.e., ID1, ID2, and ID3. Each of the child processes 1402a, 1402b, and 1402c (hereinafter, each child process is represented by 1402) acquires packets.

When receiving a process completion notification from the application unit 304, the parent process 1401 transmits the process completion notification to a corresponding child process 1402. The child process 1402 completes acquiring packets upon receipt of the process completion notification, and sends acquired data to the packet holding unit 303.

Then, the child process 1402 transmits a packet acquisition completion notification to the parent process 1401, whereupon the child process is erased. In this embodiment, the packet holding unit 303 performs the same process as that in the first embodiment described with reference to FIG. 13.

With this embodiment, child processes corresponding in number to destinations of simultaneous image transmission are created and each child process acquires packets, whereby packets transmitted to respective destinations can be acquired.

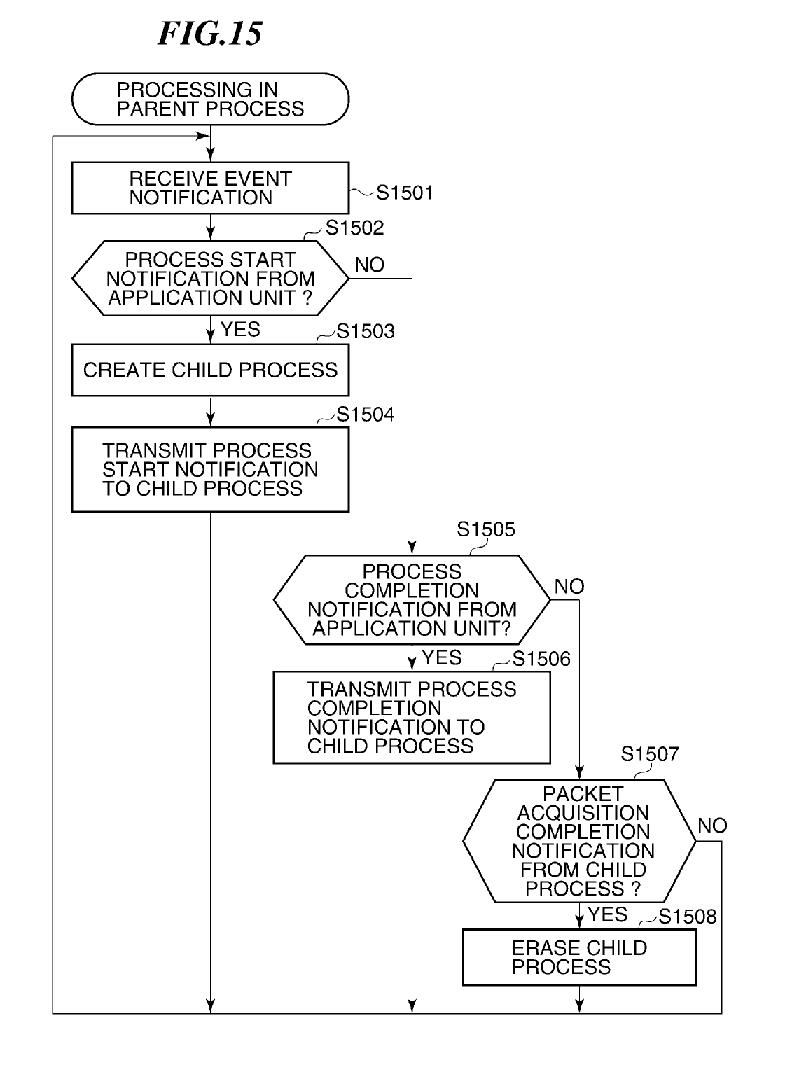

FIG. 15 shows in flowchart the procedures of processing performed by the parent process 1401.

In S1501, the parent process 1401 receives an event notification. In S1502, the parent process 1401 determines whether the received event notification is a process start notification from the application unit 304.

If it is determined in S1502 that the received event notification is a process start notification from the application unit 304, the parent process 1401 creates in S1503 a child process 1402 while assigning a process ID to it, and transmits a process start notification to the child process 1402 in S1504.

If the received event notification is not a process start notification from the application unit 304, the parent process 1401 determines in S1505 whether the received event notification is a process completion notification from the application unit 304.

If it is determined in S1505 that the received event notification is a process completion notification from the application unit 304, the parent process 1401 transmits the process completion notification to the child process 1402 in S1506. If the received event notification is not a process completion notification from the application unit 304, the parent process 1401 determines in S1507 whether the received event notification is a packet acquisition completion notification from the child process 1402.

If it is determined in S1507 that the received event notification is a packet acquisition completion notification from the child process 1402, the parent process 1401 erases the child process 1402 in S1508. If the received event notification is not a packet acquisition completion notification from the child process 1402, the parent process 1401 returns to S1501 where it waits for receiving an event notification.

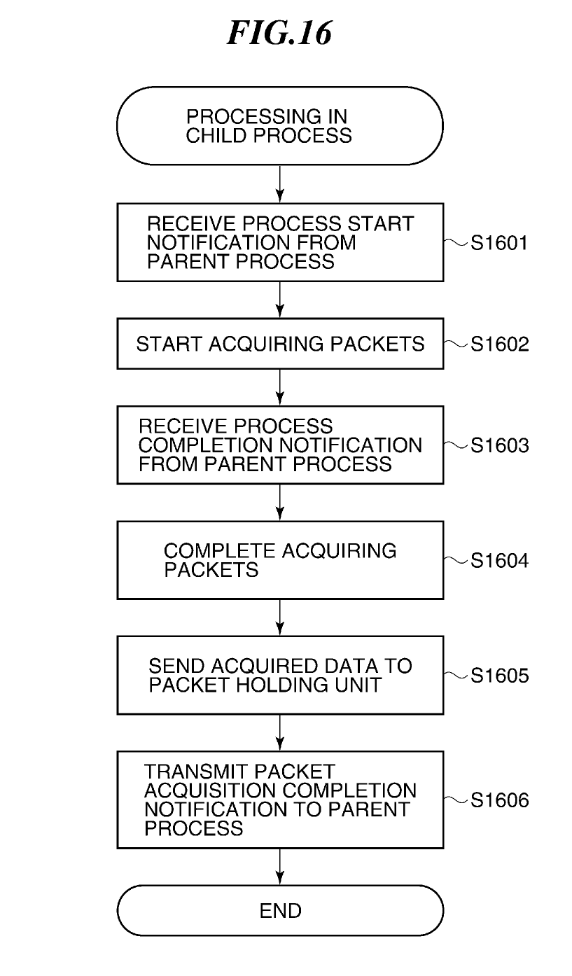

FIG. 16 shows in flowchart the procedures of processing performed by each child process 1402.

The child process 1402 receives a process start notification from the parent process 1401 in S1601, and starts acquiring packets in S1602. Subsequently, in S1603, the child process 1402 receives a process completion notification from the parent process 1401.

The child process 1402 completes acquiring packets in S1604, sends acquired data to the packet holding unit 303 in S1605, and transmits a packet acquisition completion notification to the parent process 1401 in S1606.

As described above, in the first and second embodiments, packet data is stored differently between when communication with the external apparatus has normally been completed and when the communication has not normally been completed. Normal packet data and abnormal packet data which are coincident in destination information and in protocol with each other are grouped and stored in the same folder, whereby information useful for failure analysis can efficiently be collected.

The communication apparatus of this invention determines whether data communication with the external apparatus has normally been completed. If the data communication with the external apparatus has normally been completed, data transmitted and received during the data communication is held in a first holding unit (i.e., in the normal directory in the packet holding unit 303). On the other hand, if the data communication with the external apparatus has not normally been completed, data transmitted and received during the data communication is held in a second holding unit (i.e., in the abnormal directory in the packet holding unit 303) so as to be associated with data held in the first holding unit.

If it is determined that data communication with the external apparatus has normally been completed, the communication apparatus of this invention determines whether the first holding unit already holds data for which destination information and protocol that are the same as those used in the data communication were used. If such data is not held in the first holding unit, data transmitted and received in the normally completed data communication is held in the first holding unit.

### Other Embodiments

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-066188, filed Mar. 18, 2009, which is hereby incorporated by reference herein in its entirety.

What is claimed is:

1. A communication apparatus for performing data communication with an external apparatus connected thereto via a network, comprising:
a determination unit configured to determine whether data communication with the external apparatus has normally been completed;
a first holding unit configured to hold data transmitted to and received from the external apparatus during the data communication in a case where it is determined by said determination unit that the data communication with the external apparatus has normally been completed; and
a second holding unit configured to hold data transmitted to and received from the external apparatus during the data communication so as to be associated with data held by said first holding unit in a case where it is determined by said determination unit that the data communication with the external apparatus has not normally been completed.

2. The communication apparatus according to claim 1, further including:
an extraction unit configured to extract data associated with particular destination information or a particular protocol from among data transmitted to and received from the external apparatus,
wherein said first holding unit holds data extracted by said extraction unit.

3. The communication apparatus according to claim 2, wherein in a case where it is determined that the data communication with the external apparatus has not normally been completed, said second holding unit searches for data held in said first holding unit based on destination information or a protocol used for the data communication, and holds data obtained by search together with the data transmitted and received during the data communication determined as not having been normally completed.

4. The communication apparatus according to claim 1, wherein said second holding unit stores and holds, into a same folder, the data transmitted and received during the data communication determined as not having been normally completed and the data held by said first holding unit.

5. The communication apparatus according to claim 1, further including:
a judgment unit configured, in a case where it is determined that the data communication with the external apparatus has normally been completed, to judge whether said first holding unit already holds data for which destination information and protocol that are the same as those used in the data communication were used,
wherein in a case where it is judged by said judgment unit that said first holding unit does not hold data for which destination information and protocol that are same as those used for the data communication determined as having normally been completed were used, said first holding unit holds data transmitted and received during the data communication determined as having normally been completed.

6. The communication apparatus according to claim 5, wherein in a case where it is judged by said judgment unit that said first holding unit already holds data for which destination information and protocol that are same as those used for the data communication determined as having normally been completed were used, said first holding unit holds data either the data transmitted and received during the data communication determined as having normally been completed or the already held data, whichever is smaller in size.

7. The communication apparatus according to claim 1, further including:
a reading unit configured to read an image of an original and create image data based on the image,
wherein the image data created by said reading unit is transmitted to the external apparatus in the data communication with the external apparatus.

8. A control method of a communication apparatus for performing data communication with an external apparatus connected thereto via a network, comprising:
a determination step of determining whether data communication with the external apparatus has normally been completed;
a first holding step of holding data transmitted to and received from the external apparatus during the data communication in a case where it is determined in said determination step that the data communication with the external apparatus has normally been completed; and
a second holding step of holding data transmitted to and received from the external apparatus during the data communication so as to be associated with data held in said first holding step in a case where it is determined in said determination step that the data communication with the external apparatus has not normally been completed.

9. A computer-readable storage medium storing a program for causing a computer to execute the control method as set forth in claim 8.
